(19) United States
(12) Patent Application Publication
(10) Pub. No.: US 2016/0295276 A1
(43) Pub. Date: Oct. 6, 2016

(54) METHOD AND SYSTEM FOR LOCALIZED DAY PARTING WHEN PRESENTING A SECOND VIDEO WITH ONE OR MORE FIRST VIDEOS

(71) Applicant: QDOS, Inc. d/b/a DeskSite, Irvine, CA (US)

(72) Inventor: Richard James Gillam, Irvine, CA (US)

(73) Assignee: QDOS, Inc. d/b/a DeskSite, Irvine, CA (US)

(21) Appl. No.: 14/677,543

(22) Filed: Apr. 2, 2015

(51) Int. Cl. H04N 21/433; H04L 29/06; H04N 21/472

(52) U.S. Cl. CPC H04N 21/4334; H04N 21/47214; H04L 65/1059

(57) ABSTRACT

A system and method is for local day parting on a local device for display of digital content. The system comprises a processor and a local storage device, and a first set of executable instructions that are executable on the processor configured to download digital content to the storage device upon detection of connection to a network, the first set of executable instructions further configured to download and store one or more parameters for presenting the digital content, the one or more parameters including time and date parameters. A second set of executable instructions are configured to read the local time and date of the local device and to queue the digital content to present on the local device regardless of whether the local device is connected to the network.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This invention generally relates to a method and system for localized day parting when presenting a second video with one or more first videos. More specifically, the present invention relates to a system and method that transforms electronic data in a database, in real time, as a viewer watches one or more first videos to programmatically determine when a second video should be shown to the viewer based on the local time of the device on which the first and second videos are shown, regardless of online connectivity.

### SUMMARY OF THE INVENTION

According to a preferred embodiment, a system for local day parting on a local device for display of digital content, comprises: a processor; a local storage device; a first set of executable instructions that are executable on the processor configured to download digital content to the storage device upon detection of connection to a network, the first set of executable instructions further configured to download and store one or more parameters for presenting the digital content, the one or more parameters including time and date parameters; and a second set of executable instructions configured to read the local time and date of the local device and to queue the digital content to present on the local device regardless of whether the local device is connected to the network.

According to another preferred embodiment, a method for local dayparting on a local device for display of digital content, comprises: downloading one or more digital content to the storage device upon detection of connection to a network; downloading and storing one or more parameters for presenting the digital content, the one or more parameters including time and date parameters; reading the local time and date of the local device; and queuing the digital content to present on the local device regardless of whether the local device is connected to the network according to the local time and date.

### BRIEF DESCRIPTION OF THE DRAWINGS

FIG. 1 is a diagrammatic representation of an exemplary internet-based environment in which one embodiment may operate;

FIG. 2 is a diagrammatic representation of the components of one or more of the portable or stationary user devices having a local clock according to the embodiment of FIG. 1;

FIG. 3 is a diagrammatic representation of one or more of the user devices of FIGS. 1 and 2, and a storage device with a database containing electronic data that is transformed;

FIG. 4 is a flow chart illustrating steps performed by a video display software according to the embodiment of FIGS. 1-3; and

FIG. 5 is a flow chart illustrating steps performed by video display software according to the embodiment of FIGS. 1-4.

### DETAILED DESCRIPTION OF THE PREFERRED EMBODIMENTS

For the purpose of illustrating the invention, there is shown in the accompanying drawings several embodiments of the invention. However, it should be understood by those of ordinary skill in the art that the invention is not limited to the precise arrangements and instrumentalities shown therein and described below.

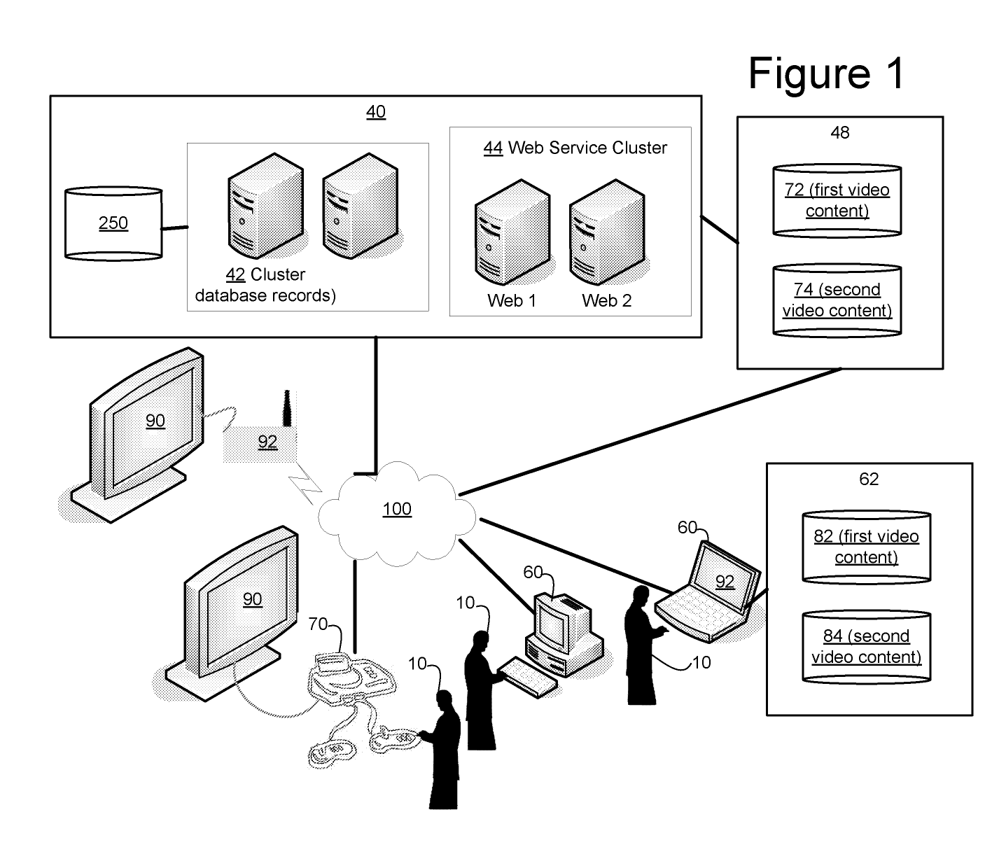

The method and system for localized day parting when presenting a second video with one or more first videos is disclosed in accordance with preferred embodiments of the present invention and is illustrated in FIGS. 1-5 wherein like reference numerals are used throughout to designate like elements.

With reference to FIG. 1, a diagrammatic representation of an exemplary internet-based system is shown in which the system and method may operate according to one embodiment. As is typical on today's internet 100, users 10 may connect to and use the internet 100 over several platforms. Those platforms may include personal computers 60, mobile phones, tablets, or the like. One of the latest ways to connect to the internet includes using internet protocol television, or IPTV, boxes 92. These IPTV boxes 92 include a wireless or wired device that has a memory and storage for applications or apps that connects to the internet 100. Through an IPTV box 92, users may use the apps contained therein to display videos, pictures, and internet sites on a television (TV) 90. The television is typically connected to the IPTV box 92 via an HDMI cord, component cable, or audio/video (A/V) input lines.

Further, modern game consoles 70 are now capable of video play. Game consoles 70 such as the XBOX®, Playstation®, Nintendo®, Wii®, and others, provide for internet video presentation. Just as with the IPTV box 92, game consoles 70 typically connect to a TV 90 on which the video may be viewed.

What may be common among all of these user devices 60, 92, 70 is that they typically have their own internal digital clocks that may be set to the local time of the user 10 who is using the device. For example, a user 10 in Los Angeles, Calif., may be using a device 60 with the internal clock set to 12:00 pm Pacific Standard Time (PST), and a user 10 in New York, N.Y., may be using a device 70 at the same time with the internal clock set to 3:00 pm Eastern Standard Time (EST) due to the different time zones. In many cases the clock on the user device 60, 92, 70 may be set according to a local network or internet service provider (ISP) to which the user device 60, 92, 70 is logged into.

One or more servers 40 may include one or server clusters 42 and one or more web front end servers 44. One or more storage devices 250 may further be included. Further, within the server 40, or external to the server 40, one or more network video storage systems 48 may be included to store digital content, for example, such as videos. The network video storage system 48 may include a primary or first video database 72 and a secondary or second video database 74. For example, the first video database 72 may store a plurality of first videos that may be downloaded to user devices 60, 92, 70, and the second video database 74 may store a plurality of second videos that may be downloaded to user devices 60, 92, 70 while each user device 60, 92 70 are online.

Once downloaded, the first videos may be stored in a relative local first video database 82 and the second videos may be stored in a relative local second video database 84 on a local storage system 62 on each of the user devices 60, 92, 70. As those of skill in the art may recognize, instead of using up internet connection resources during peak usage of the user devices 60, 92, 70, the first and second videos may be downloaded in the background when internet usage of each user device 60, 92, 70 is low.

Once downloaded one or more of the second videos may be presented before, during or after the one or more first videos. By way of example, and not by way of limitation, the first videos may include user searchable videos for presentation to the users, and the second videos may include a plurality of advertising videos that may be presented within the presentation of the first videos. In one embodiment, instead of the first and second videos being stored in two databases, both the first and second videos may be stored in the same database, but, for example, in different database files or folders for organizational purposes.

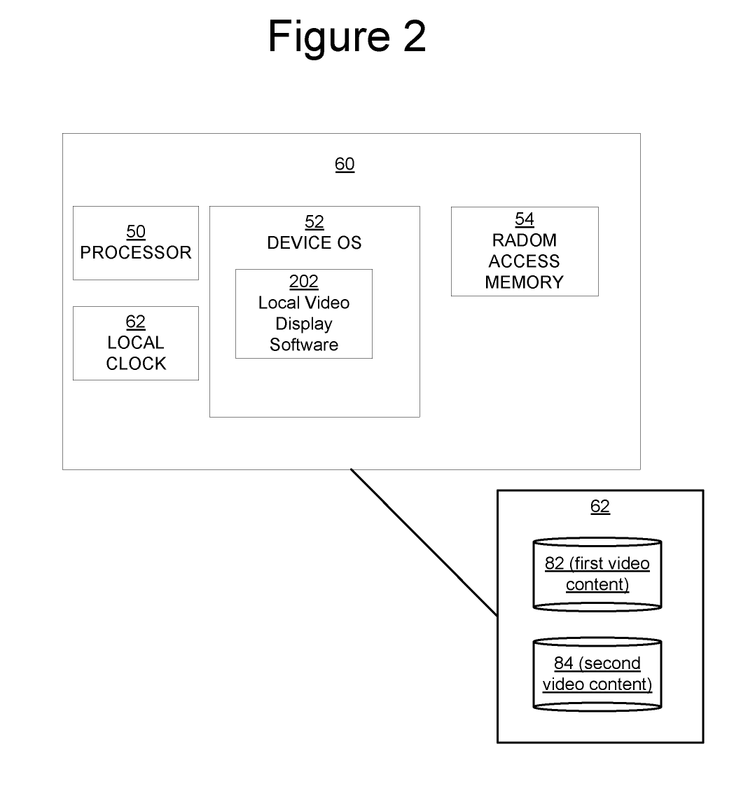

With reference to FIG. 2 a diagrammatic representation of the internal components of one or more of the user devices 60 (92, 70 in FIG. 1) is shown. As those skilled in the art would recognize, each user device 60, 92, 70 may include a processor 50, on which executable instructions of an app or computer program 202 may execute. As those skilled in the art would recognize the computer program, which may embody the video display software 202, may be loaded by an operating system 52 running on each user device 60, 92, 70. Further, the user devices 60, 92, 70 may each have a random access memory (RAM) 54 that may be used for loading programs, and storing program variable data, such as an online-offline flag 204 used by the video display software 202 to keep track of when the user device 60, 92, 70 is online or offline for downloading and upload data as explained above.

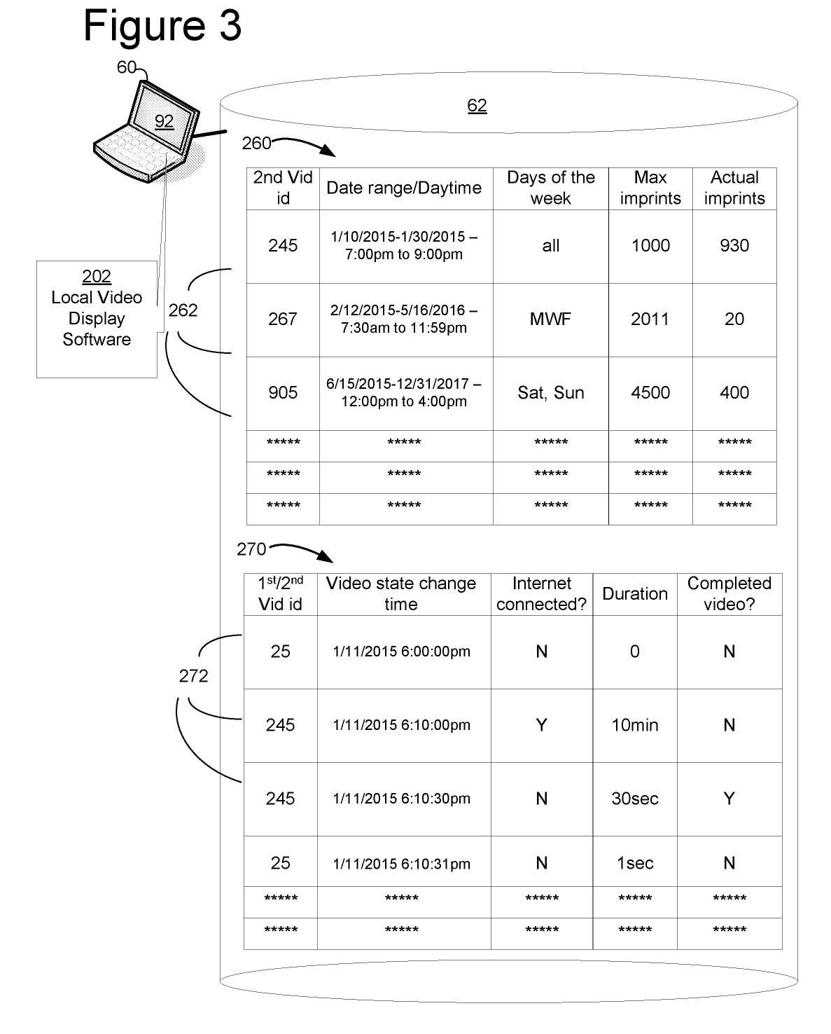

With reference to FIG. 3, a diagrammatic representation of the one or more user devices 60 (92, 70 in FIG. 1), and the storage device 62, is shown. As indicated above, each user device 60, 92, 70 may have executing within it video display software 202. The video display software 202 may comprise instructions to retrieve and display videos from the local first video database 82 according to requests received by users 10. The storage device 62 may store one or more databases to manage presentation of the second videos with the showing of the first videos. An exemplary database table 260 is shown in FIG. 3 illustrating some of the electronic data that may be stored and transformed to manage first and second video playback within presentation of the first videos. For example, each record of table 260 may contain second video identification data, date range and daytime parameters to define when the second video should be shown, the days of the week that the second video should be shown, the maximum total imprints of the second video, and the actual imprints so the number of imprints of each second video can be tracked for each user. This can be useful, for example, when the second videos comprise advertisements, and the web server owner is paid for the number of presentations of the second videos to selected user profiles.

In this regard, the web server owner, or owners of the second videos, may require that certain second videos be shown at certain number of times to each or certain users 10, and thus, included in each record 262 of the table 260 may be an impression or shown count field for each video identifier identified in a second video identifier field. This and other data in the record 262 may be referred to as consumption metadata.

Further, other tables may be included, by way of example, and not by way of limitation, a table 270 for storing online/offline status during 1^{st} video and 2^{nd} video playback. During video playback, it may be desirable to detect, store, and upload the online status data to the server (40 in FIG. 1) to store in a database in storage device (250 in FIG. 1) when the user device 60 is online. In this regard, each record 272 of the online status table may contain a field for the 1^{st} video or 2^{nd} video identifier for the video being played starting at a time recorded in the video state change field. The online/offline status may be recorded for that time in a internet connected status field. The duration between recorded state changes may be stored in a duration field. Further, a video completed field records whether the video was completed for the specified state change.

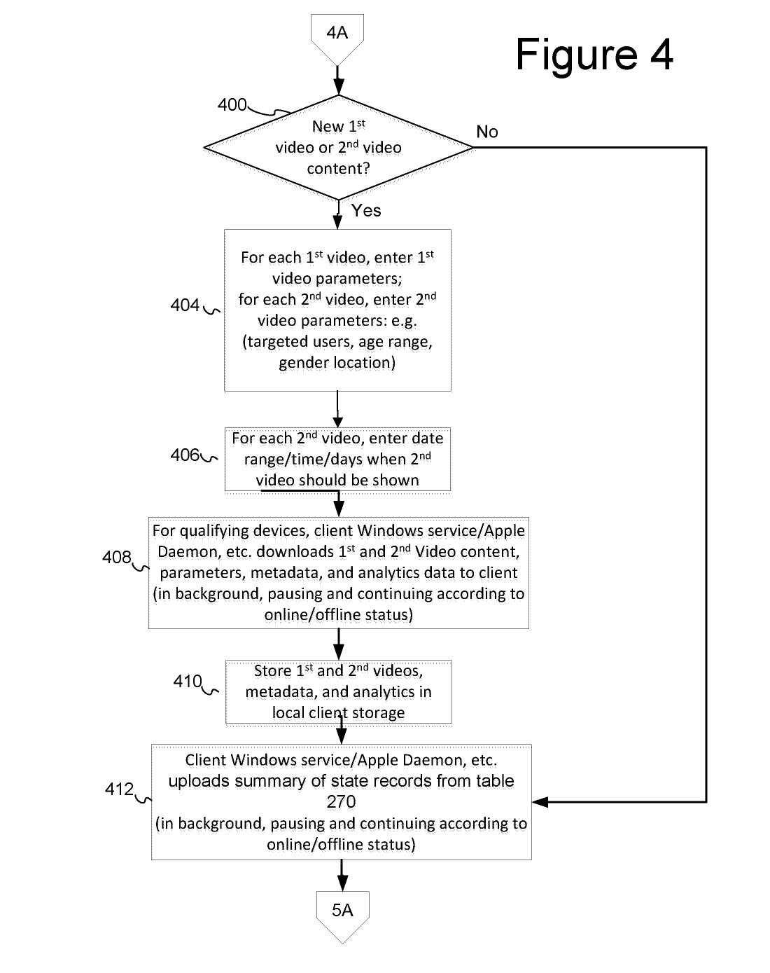

With reference to FIG. 4, a flow chart illustrating steps performed by the video display software 202 according to the embodiment of FIGS. 1-3 is shown. In step 400, it is determined whether new 1^{st} or 2^{nd} video content needs to be added to the network video storage system 48. If so, then in step 404, parameters for the 1^{st} and 2^{nd} videos that are added to the network video storage system 48 in storage device 250, as the 1^{st} and 2^{nd} videos are added to video storage devices 72 and 74. The second video parameters that may be entered in to storage device 250 may include, by way of example, and not by way of limitation, parameters for the targeted users, such as age range, gender, geographic region, and the like. In step 406, parameters for the second videos relating to the date range/times/days when each second video should be shown may be entered into storage device 250. In step 408, for qualifying devices, the client Windows service/Apple daemon, or the like for the particular device, downloads (pulls) 1st and 2nd video content, parameters, metadata, and analytics data to the user device 60, 92 70 (in background, pausing and continuing according to online/offline status).

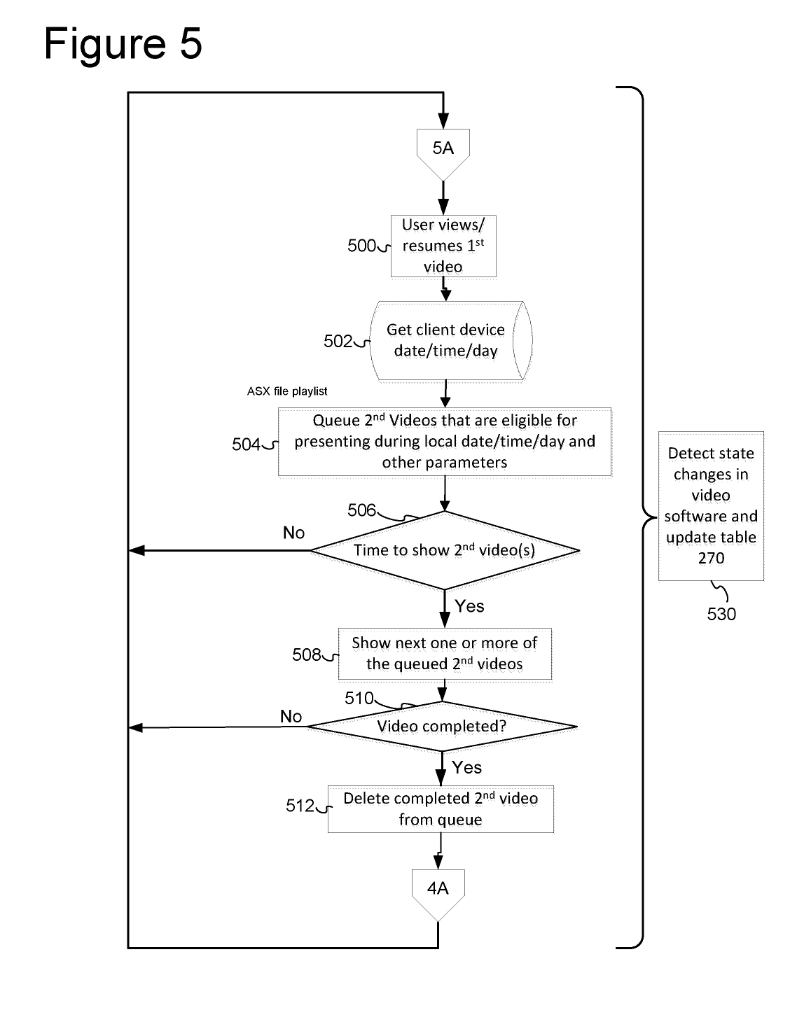

In step 410, as the user device 60, 92 70 receives the data downloaded by the Windows service/Apple daemon, the 1^{st} and 2^{nd} videos may be stored in local video storage folders or disks 82 and 84 within local storage device 62 respectively. In step 410, the client Windows service/Apple Daemon, or equivalent for the device, uploads a summary of state records from table 270 to the server 40 for storage in database 250. Processing moves to FIG. 5.

With reference to FIG. 5, a flow chart illustrating steps performed by the video display software according to the embodiment of FIGS. 1-4 is shown. In step 500, a user may begin or resume viewing one of the first videos. In step 502, a library call or procedure call (i.e. in the .NET framework for example) may be used to determine the locale device system date and time (and therefore day of the week). Further, in step 504, a queue containing pointers to the 2nd videos that are eligible for presenting according to the parameters, including the local date/time/day obtained in step 502. The queue may be prioritized, for example, according to the second videos for which the required number of impressions are due within the time frame for the second video to be shown, and other prioritizations.

In step 506, the local video display software may check for whether, according to first video parameters, it may be time to show one or more of the second videos referred to in the queue. If so, then in step 508, the next one or more second videos are shown. In step 510, the local video display software determines whether each second video is completed. If so, in step 512, each completed 2^{nd} video may be removed from the queue. Processing then moves back to step 400 in FIG. 4.

It should be noted that the local video display software 202 may not comprise its own video player. For many reasons regarding compatibility, it may be more advantageous to show first and second videos in the native video display software as part of the operating system. For example, Windows may use the Windows Media Player® as the standard video play software. This may present a problem with respect keeping track of display actions in the standard video window of the display software. Thus, in step 530 of FIG. 5, the local video display software 202 may detect state changes in video software and update table 270 of FIG. 3.

Upon detection of a state change in presenting the first or second video, the local video display software 202 may read the system date and time, the internet connection state, and the current duration time for the play of the video and therefore whether the currently playing video has completed or not (by comparing the duration of the current video to the current duration of playing time). Thus, in step 530 of FIG. 5, the local video display software 202 then transforms the data in data table 270 to reflect this information.

It should be noted that while examples related to advertisement-type videos may have been used, those of skill in the art may now recognize that many types of second videos may be presented using embodiments described here. By way of further example, and not by way of limitation, the second videos may comprise public service announcements, AMBER ALERTS, or other useful content. As a further example, the second videos may be related to the first videos, for example providing information on product placements in the first videos, or further information about actors, plots, or characters in the first videos.

The various embodiments described above are provided by way of illustration only and should not be construed to limit the invention. Those skilled in the art will readily recognize various modifications and changes that may be made to the claimed invention without following the example embodiments and applications illustrated and described herein, and without departing from the true spirit and scope of the claimed invention, which is set forth in the following claims.

1. A system for local day parting on a local device for display of digital content, comprising:
a processor;
a local storage device;
a first set of executable instructions that are executable on the processor configured to download digital content to the storage device upon detection of connection to a network, the first set of executable instructions further configured to download and store one or more parameters for presenting the digital content, the one or more parameters including time and date parameters; and
a second set of executable instructions configured to read the local time and date of the local device and to queue the digital content to present on the local device regardless of whether the local device is connected to the network.

2. The system of claim 1, wherein the time and date parameters comprise a day of the week parameter.

3. The system of claim 1, wherein the digital content comprises a video.

4. The system of claim 1, wherein the digital content comprises a first and a second video.

5. The system of claim 2, wherein the first video comprises a video selected by a user for playing.

6. The system of claim 3, wherein the second video comprises an advertisement video that is shown with the first video based on the one or more parameters.

7. The system of claim 1, further comprising a daemon for downloading the digital content.

8. A method for local day parting on a local device for display of digital content, comprising:
downloading one or more digital content to the storage device upon detection of connection to a network;
downloading and storing one or more parameters for presenting the digital content, the one or more parameters including time and date parameters;
reading the local time and date of the local device; and
queuing the digital content to present on the local device regardless of whether the local device is connected to the network according to the local time and date.

9. The method of claim 8, wherein the time and date parameters comprise a day of the week parameter.

10. The method of claim 8, wherein the digital content comprises a video.

11. The method of claim 8, wherein the digital content comprises a first and second video.

12. The method of claim 8, wherein the first video comprises a video selected by a user for playing.

13. The method of claim 12, wherein the second video comprises an advertisement video that is shown with the first video based on the one or more parameters.

14. The method of claim 8, further downloading the digital content using a daemon.
